(19) United States
(12) Patent Application Publication
(10) Pub. No.: US 2001/0028527 A1
(43) Pub. Date: Oct. 11, 2001

(54) NOISE AND VIBRATION DAMPING DEVICE OF ROTATION DRIVING APPARATUS

(75) Inventors: BYOUNG-YOUNG BAE, PYUNGTACK-CITY (KR); SOON-KYO HONG, SEOUL (KR); SEONG-HOON KIM, SUNGNAM-CITY (KR); SUNG-JIN LEE, GWANGMYUNG-CITY (KR); BYEONG-CHEON KOH, SUNGNAM-CITY (KR)

Correspondence Address: SUGHRUE MION ZINN MACPEAK AND SEAS PLLC, 2100 PENNSYLVANIA AVENUE NW, WASHINGTON, DC, 200373202

(73) Assignee: SAMSUNG ELECTRONICS CO., LTD.

(21) Appl. No.: 09/359,905

(22) Filed: Jul. 26, 1999

(30) Foreign Application Priority Data
Jul. 28, 1998 (KR) 98-30383

(51) Int. Cl. G11B 17/02

(52) U.S. Cl. 360/97.02

(57) ABSTRACT

A noise and vibration damping device of a rotation driving apparatus includes a housing in which a body is rotatably installed, and a driving source that rotates the body. Speed reducing filters are installed on inner surfaces of the housing for reducing the speed of air flow within the housing generated by the rotation of the body.

### BACKGROUND OF THE INVENTION

1. Field of the Invention

The present invention relates to a noise and vibration damping device of a rotation driving apparatus, such as a hard disk drive (HDD), a digital versatile disk (DVD) drive, and a CD-ROM drive. The damping device dampens noises and vibrations which are generated by air flow within a sealed housing when a body such as hard disks rotates.

2. Description of the Related Art

FIG. 1 shows an HDD as an example of a rotation driving apparatus. The HDD comprises a housing 10, hard disks 18 rotatably installed in the housing 10, and a noise and vibration damping device.

The housing 10 is installed in a computer main body (not shown), and comprises a base 12 for supporting the hard disks 18 as a recording medium, and a cover frame 14 assembled to the base 12 for protecting the hard disks 18.

While the hard disks 18 are rotated by a driving source such as a spindle motor (not shown) installed in the housing 10, data is written to the hard disks 18 or written data is read from the hard disks 18 by a predetermined data writing/reading means (not shown). In addition, multiple hard disks 18 are usually employed to increase storage capacity.

The noise and vibration damping device is attached to the outer surface of the cover frame 14 by an adhesive, such as a bond or a double-sided bonding tape, and comprises a damper member 16, which is usually a thin plate structure manufactured from stainless steel.

With reference to FIG. 2, when the hard disk 18 is rotated by the spindle motor so as to write data to or read written data from the hard disk 18, the air within the housing 10 flows in θ and R directions. Here, the air flowing in a θ direction is distributed at irregular pressures with respect to the R directions, and the air flows irregularly. The irregular air flow impacts the inner walls of the housing 10. The housing 10 is vibrated by the impact, and consequently, undesirable noise is generated. The irregularity of the air flow is increased because structural parts (such as an actuator arm 19) installed within the housing obstruct the air flow within the housing. Thus, the speed of the air flow increases as air moves toward a comer portion C of the cover frame 14. Consequently, the vibration of the housing 10 intensifies, and noise increases. Such noise is damped to some extent by the damper member 16 absorbing the vibration of the housing 10.

Although conventional damper members 16 are generally thought to be acceptable, they are not without shortcomings. Specifically, since the damper member 16 for damping noise must be separately attached to the outer surface of the housing 10, the manufacturing cost is high and more assembly operations are required. In addition, when the temperature within a computer main body rises, the bonding force of the adhesive deteriorates. Further, since the air flow causing the noises is not fundamentally restrained, the function of the damper member 16 is limited to damping noise.

### SUMMARY OF THE INVENTION

An objective of the present invention is to provide a noise and vibration damping device of a rotation driving apparatus having an improved structure that dampens noises and vibrations by reducing the speed of air flow within a housing.

To achieve the above objective, the noise and vibration damping device of a rotation driving apparatus includes: a housing; a body rotatably installed in the housing; a driving source for driving the body; and speed reducing filters installed on inner surfaces of the housing for reducing the speed of air flow within the housing generated by the rotation of the body.

Here, it is preferable that the housing includes: a base on which the body is installed; and a cover frame assembled to the base for covering the body.

In addition, it is preferable that the speed reducing filters are installed on a surface of the base and/or a surface of the cover frame which face the body, respectively, or installed on an inner side surface of a containing portion of the housing for containing the body.

Further, it is preferable that receiving recesses are formed at the inner side surface of the containing portion for receiving the speed reducing filters.

Finally, it is preferable that a noise and vibration damping device according to the present invention further includes a damper member installed on an outer surface of the housing for damping noises and vibrations generated by the rotation of the body.

The above and other features of the invention including various and novel details of construction and combination of parts will now be more particularly described with reference to the accompanying drawings and pointed out in the claims. It will be understood that the particular noise and vibration damping device embodying the invention is shown by way of illustration only and not as a limitation of the invention. The principles and features of this invention may be employed in varied and numerous embodiments without departing from the scope of the invention.

### BRIEF DESCRIPTION OF THE DRAWINGS

FIG. 1 is a partially cut away perspective view schematically illustrating a hard disk drive;

FIG. 2 is a perspective view of a portion of the hard disk drive shown in FIG. 1 for describing air flow within a housing when hard disks of the hard disk drive rotate;

FIG. 3 is an exploded perspective view illustrating a noise and vibration damping device of a rotation driving apparatus according to a preferred embodiment of the present invention;

FIGS. 4 through 6 are schematic bottom views illustrating various embodiments of the cover frame shown in FIG. 3;

FIGS. 7A through 7C are perspective views each illustrating a portion of various embodiments of speed reducing filters shown in FIG. 3;

FIG. 8 is a perspective view of a portion of the rotation driving apparatus shown in FIG. 3 for describing the operation of a noise and vibration damping device of the rotation driving apparatus; and

FIG. 9 is an exploded perspective view illustrating a noise and vibration damping device of a rotation driving apparatus according to another embodiment of the present invention.

### DESCRIPTION OF THE PREFERRED EMBODIMENTS

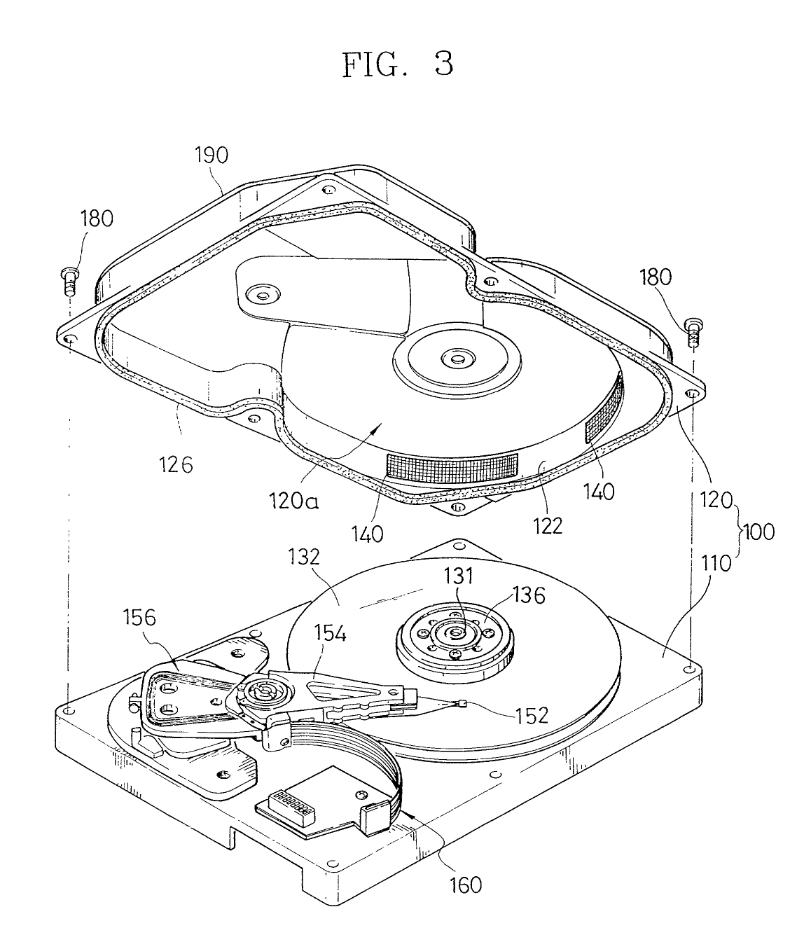

Referring to FIG. 3, a noise and vibration damping device of a rotation driving apparatus according to a preferred embodiment of the present invention comprises a housing 100, hard disks 132 as a body rotatably installed in the housing 100, a spindle motor (not shown) as a driving source, and speed reducing filters installed on the inner side surface of the housing 100.

The housing 100 comprises a base 110 and a cover frame 120. The hard disks 132 are supported by a damper 136 on the rotating shaft 131 of the spindle motor installed on the base 110. In addition, an actuator arm 154 and a voice coil motor 156 are installed on the base 110. The actuator arm 154 has a head 152 as a writing/reading means installed at one end thereof. The actuator arm 154 is pivoted by the drive of the voice coil motor 156 in a radial direction of the hard disks 132. Here, a plurality of hard disks 132 are stacked for increased data storage capacity.

The cover frame 120 assembled to the base 110 by screws 180 has a containing portion 120a for containing and covering the hard disks 132. In addition, a gasket 126 is interposed between the cover frame 120 and the base 110. The gasket 126 seals the gap between the cover frame 120 and the base 110, and restrains noises and vibrations generated in the base 110 from transferring to the cover frame 120.

Speed reducing filters 140, for reducing the speed of air flow within the housing 100 generated when the hard disks 132 rotate, are bonded by an adhesive on an inner side surface 122 of the containing portion 120a. Here, it is preferable that the speed reducing filters 140 are installed on comer portions of the containing portion 120a, i.e., the edges of the cover frame 120 where the speed of air flow becomes faster.

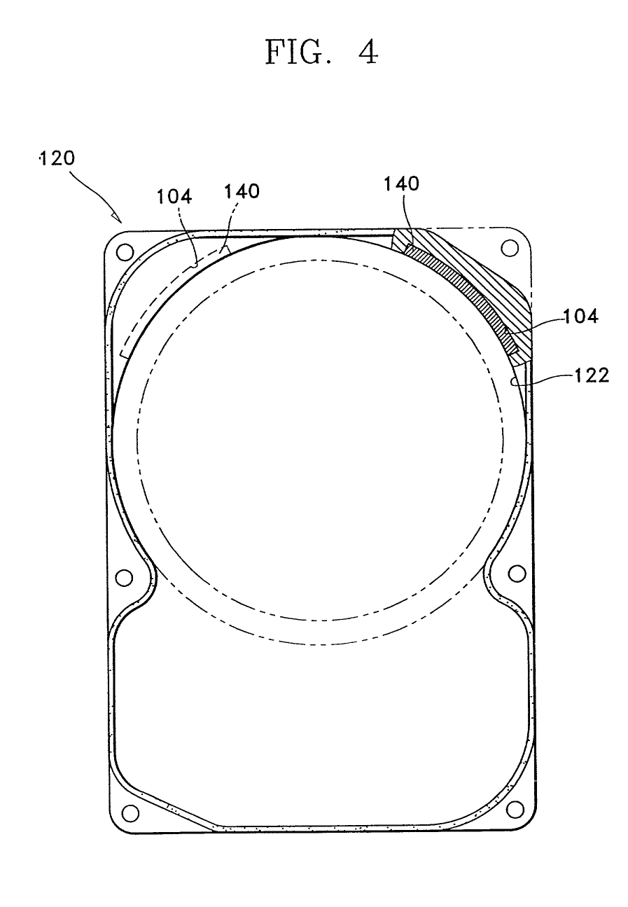

In order to prevent turbulent flow from occurring due to collision of air flow with the speed reducing filters 140, it is preferable that receiving recesses 104 for receiving the speed reducing filters 140 are formed at the inner side surface 122 as shown in FIG. 4. The receiving recesses 104 are formed by recessing the inner wall 122 to a predetermined depth, i.e., the thickness of the speed reducing filters 140.

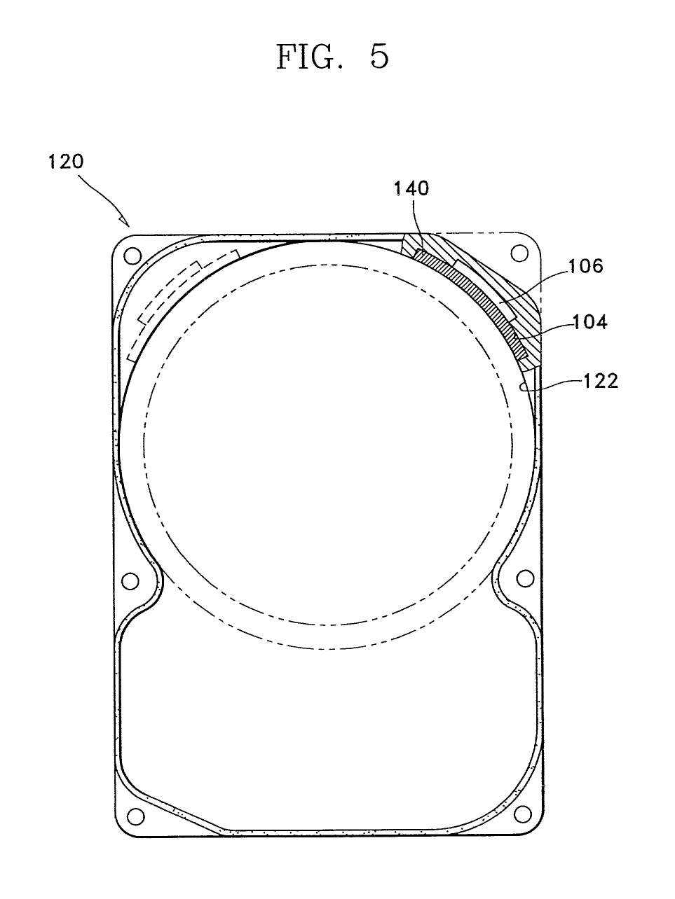

In addition, as shown in FIG. 5, in each receiving recess 104, a hollow portion 106 having a predetermined depth from the receiving recess 104 may be further formed. The hollow portion 106 is intended to form an air layer by making a space behind the speed reducing filter 140 inserted into the receiving recess 104. The air layer formed by such a hollow portion 106 serves as a buffer between the speed reducing filter 140 and the cover frame 120. That is, the air in the hollow portion 106 maintains a somewhat stable state since it is shielded from the flowing air within the housing 100 by the speed reducing filter 140, and absorbs vibrations generated in the cover frame 140.

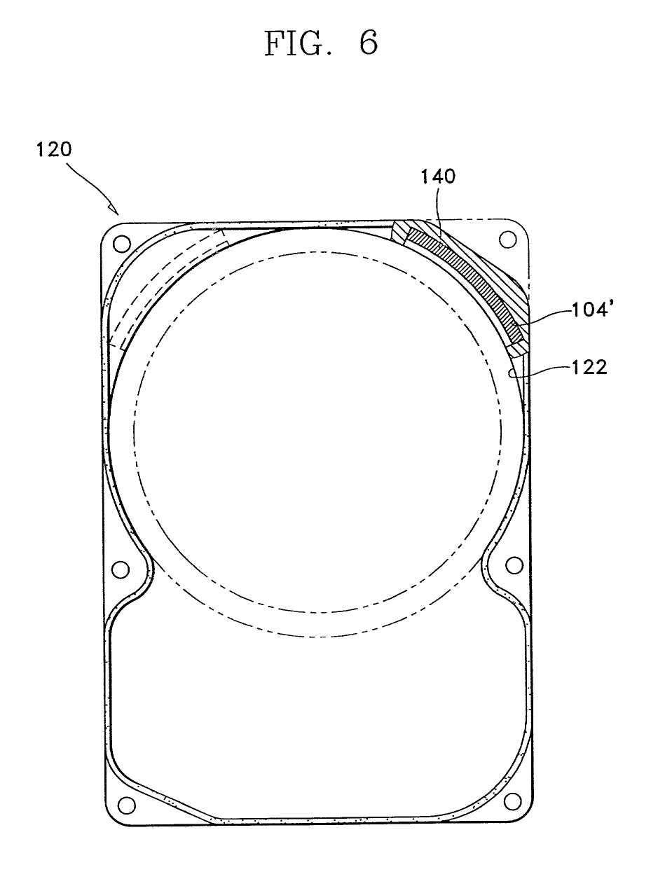

On the other hand, as shown in FIG. 6, receiving recesses 104′ may be formed at the inner side surface 122 by a depth larger than the thickness of the speed reducing filter 140. In this case, the speed reducing filter 140 is inserted into the receiving recess 104′ to a predetermined depth from the inner side surface 122. The space within the receiving recess 104′ that is not occupied by the speed reducing filter 140 induces air flowing at high speed within the housing. The flow speed of the induced air is reduced by the speed reducing filter 140. That is, air flow is induced toward the speed reducing filter 140 by inserting the speed reducing filter 140 into the receiving recess 104′ to a predetermined depth from the inner side surface 122.

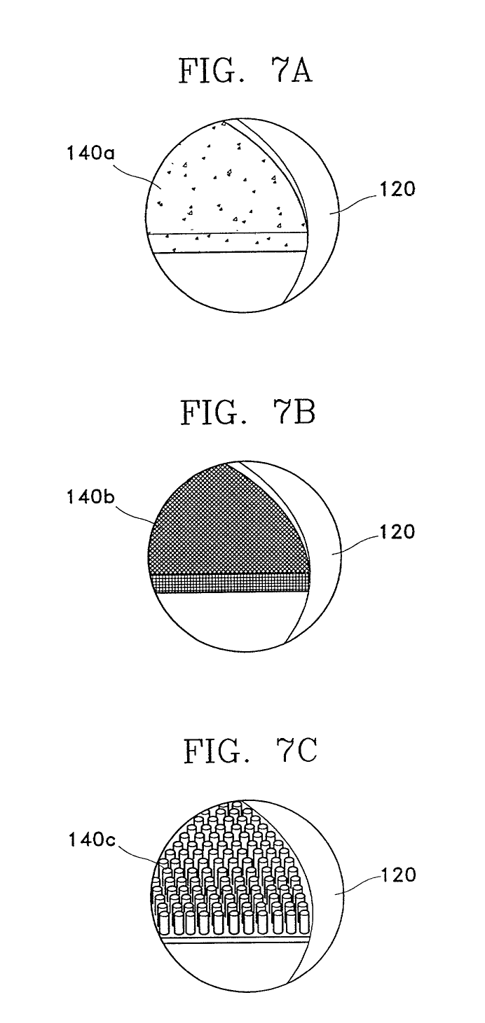

The speed reducing filter 140 may be a sponge type filter 140a of a porous structure shown in FIG. 7A which experiences less impact when flowing air collides against it, a mesh type filter 140b shown in FIG. 7B, or a brush type filter 140c shown in FIG. 7C. Since the mesh type filter 140b and the brush type filter 140c have wide air contacting areas, the flow speed of air passing through them can be effectively reduced due to friction therebetween.

The noise and vibration damping device of a rotation driving apparatus operates as follows.

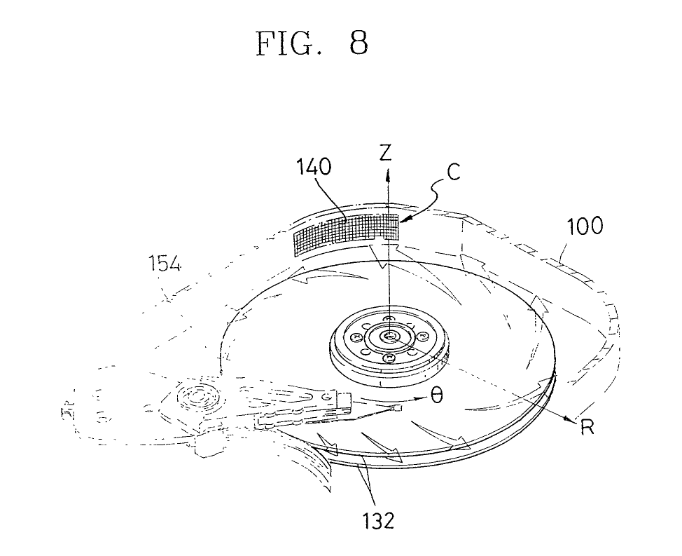

First, the rotation of the hard disks 132 during data writing/reading operations causes air within the housing 100 to flow. Although the speed and directions of such air flow are not constant, the directions can be generally classified into θ, R and Z directions as shown in FIG. 8. In addition, speeds of such air flows are proportional to the rotation speed of the hard disks 132.

When the air flowing in the θ0 direction collides with the speed reducing filter 140, the air is filtered by the speed reducing filter 140 and the air flow speed is decelerated. In particular, the air flow speed is decelerated at the comer portion C of the housing 100. Therefore, the noises and vibrations generated in the housing 100 can be damped.

If it is necessary to further reduce the noises and vibrations of the cover frame 120, a damper member 190 may be installed on the upper surface of the cover frame 120 as shown in FIG. 3. The damper member 190 may be fabricated from stainless steel, and can be attached to the cover frame 120 using an adhesive.

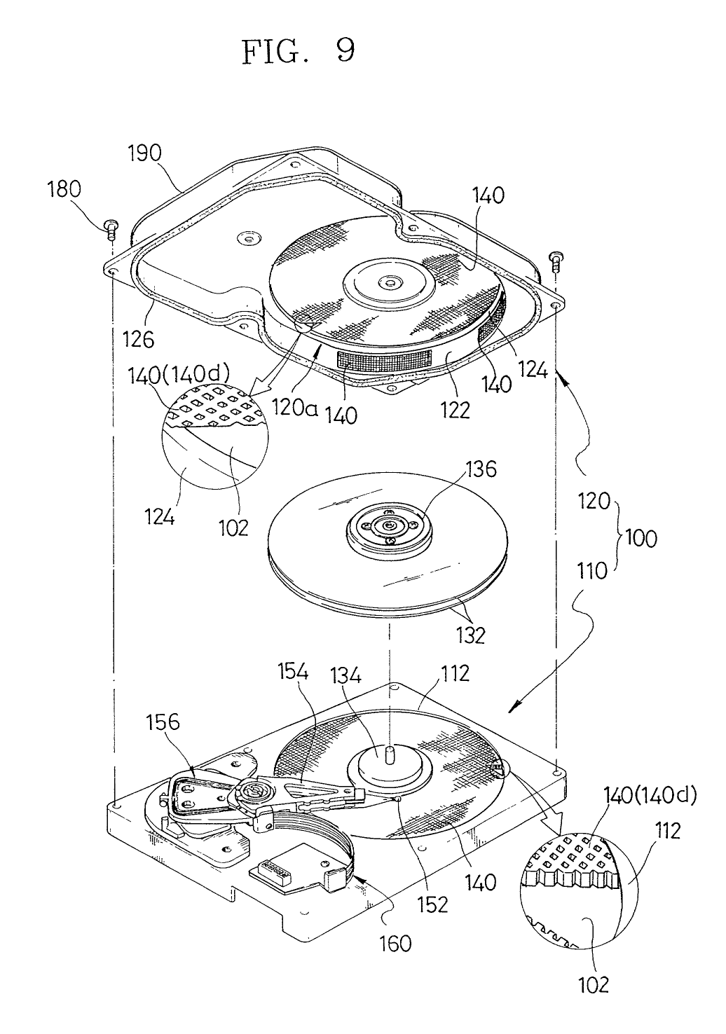

FIG. 9 shows a noise and vibration damping device of a rotation driving apparatus according to another embodiment of the present invention. In FIG. 9, the elements indicated by the same reference numerals appearing in FIG. 3, are the same members having the same functions. As shown in FIG. 9, the speed reducing filters 140 are installed on the upper surface 112 of the base 110 and the lower surface 124 of the cover frame 120, as well as the inner side surface 122 of the containing portion 120a.

It is preferable that the speed reducing filters 140 bonded to the upper surface 112 and the lower surface 124 by an adhesive is a honeycomb type filter 140d which has a doughnut shape. Alternatively, the honeycomb type filter 140d can be replaced by a sponge type filter 140a, mesh type filter 140b, or brush type filter 140c, as shown in FIGS. 7A through 7C, respectively.

In addition, it is preferable to form receiving recesses 102, for receiving the honeycomb type filters 140d, at the upper surface 112 and the lower surface 124, respectively. The receiving recesses 102 are formed considering the shape and thickness of the honeycomb type filter 140d. If the honeycomb filter 140 projects from the upper surface 112 or the lower surface 124, turbulent air flow is generated due to collision of flowing air against the projected honeycomb filter 140d. Therefore, it is preferable that the receiving recesses 102 are formed to have a predetermined depth to avoid turbulent air flow. Reference numeral 134 in FIG. 9 indicates a spindle motor for rotating the hard disks 132.

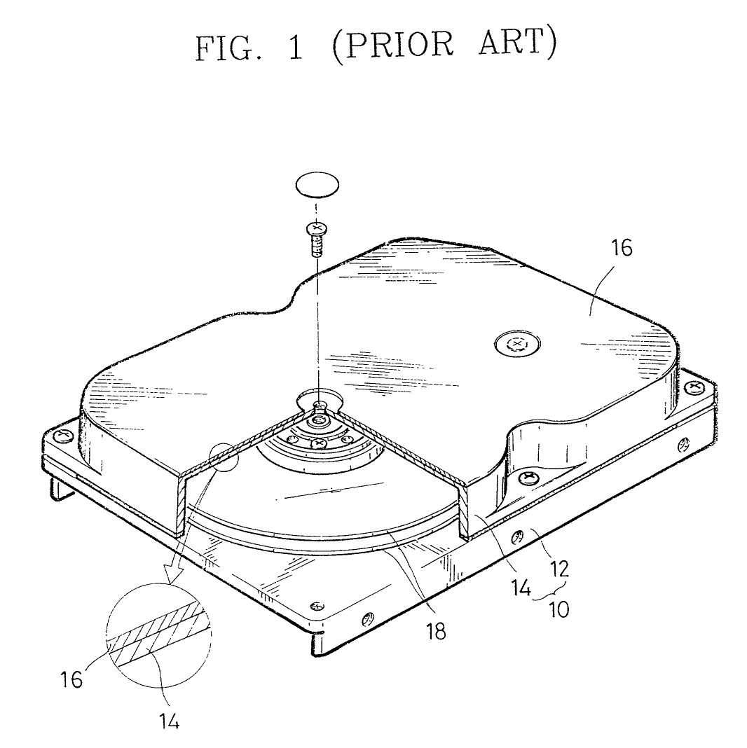

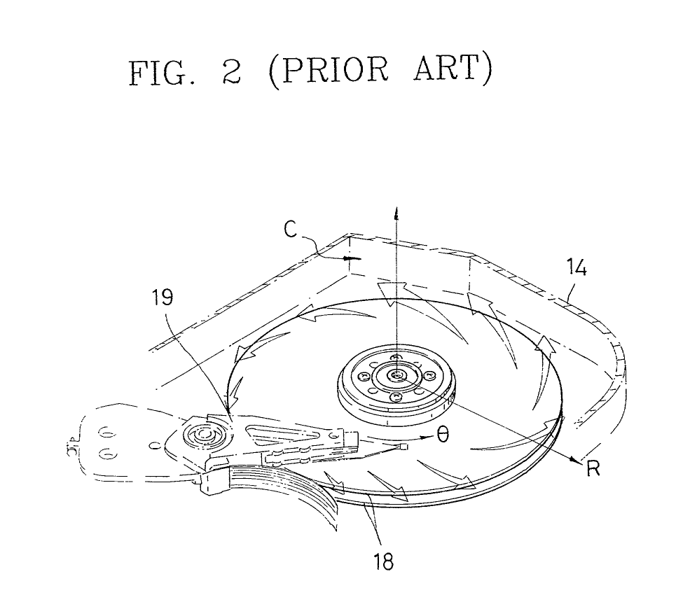

In the above structure, the speed of air flowing in the R and Z directions as well as in the θ direction with respect to the hard disks 132 can be decelerated by providing the speed reducing filters 140 on the upper surface 112 and the lower surface 124, as well as the inner side surface 122. In particular, the air flow speed, which causes noise and vibrations of the cover frame 120, is reduced. Therefore, without the conventional damper member 16 (FIG. 1), noises and vibrations due to the rotation of the hard disks 132 are effectively reduced.

In addition, when the damper member 190 for damping noises and vibrations is installed on the upper surface of the cover frame 120, noises and vibrations can be reduced even more.

In the above-described device for damping noises and vibration for a rotation driving apparatus according to the present invention, air flow speed within the housing is effectively reduced by installing speed reducing filters on inner surfaces of a housing. Consequently, the stability, reliability, and quality are enhanced.

What is claimed:

1. A noise and vibration damping device of a rotation driving apparatus, the device including:
a housing;
a body rotatably installed in the housing;
a driving source for rotating the body; and
speed reducing filters installed on inner surfaces of the housing, for reducing the speed of air flow within the housing generated by the rotation of the body.

2. The noise and vibration damping device of a rotation driving apparatus as claimed in claim 1, wherein the housing comprises:
a base on which the body is installed; and
a cover frame assembled to the base, and covering the body.

3. The noise and vibration damping device of a rotation driving apparatus as claimed in claim 2, wherein the speed reducing filters are installed on one of a surface of the base facing the body and a surface of the cover frame facing the body.

4. The noise and vibration damping device of a rotation driving apparatus as claimed in claim 1, wherein the housing includes a containing portion that contains the body, and the speed reducing filters are installed on an inner side surface of the containing portion

5. The noise and vibration damping device of a rotation driving apparatus as claimed in claim 4, wherein the inner side surface of the containing portion is provided with receiving recesses that receive the speed reducing filters.

6. The noise and vibration damping device of a rotation driving apparatus as claimed in claim 1, further comprising a damper member installed on an outer surface of the housing that dampens noises and vibrations generated by the rotation of the body.

7. The noise and vibration damping device of a rotation driving apparatus as claimed in claim 2, further comprising a damper member installed on an outer surface of the housing that dampens noises and vibrations generated by the rotation of the body.

8. The noise and vibration damping device of a rotation driving apparatus as claimed in claim 3, further comprising a damper member installed on an outer surface of the housing that dampens noises and vibrations generated by the rotation of the body.

9. The noise and vibration damping device of a rotation driving apparatus as claimed in claim 4, further comprising a damper member installed on an outer surface of the housing that dampens noises and vibrations generated by the rotation of the body.

10. The noise and vibration damping device of a rotation driving apparatus as claimed in claim 5, further comprising a damper member installed on an outer surface of the housing that dampens noises and vibrations generated by the rotation of the body.

11. A noise and vibration damping device of a rotation driving apparatus, the device including:
a housing with an inner surface;
a body mounted for rotation in the housing; and
a speed reducing filter installed on the inner surface of the housing, for reducing the speed of air flow within the housing generated by the rotation of the body.

12. The noise and vibration damping device of a rotation driving apparatus as claimed in claim 11, wherein the housing comprises:
a base on which the body is installed; and
a cover assembled to the base, and covering the body.

13. The noise and vibration damping device of a rotation driving apparatus as claimed in claim 12, wherein the speed reducing filter is installed on one of a surface of the base facing the body and a surface of the cover facing the body.

14. The noise and vibration damping device of a rotation driving apparatus as claimed in claim 11, wherein the housing includes a containing portion that contains the body, and the speed reducing filter is installed on an inner side surface of the containing portion.

15. The noise and vibration damping device of a rotation driving apparatus as claimed in claim 14, wherein the inner side surface of the containing portion is provided with a receiving recess that receives the speed reducing filter.

16. The noise and vibration damping device of a rotation driving apparatus as claimed in claim 11, further comprising a damper member installed on an outer surface of the housing that dampens noises and vibrations generated by the rotation of the body.

17. The noise and vibration damping device of a rotation driving apparatus as claimed in claim 12, further comprising a damper member installed on an outer surface of the housing that dampens noises and vibrations generated by the rotation of the body.

18. The noise and vibration damping device of a rotation driving apparatus as claimed in claim 13, further comprising a damper member installed on an outer surface of the housing that dampens noises and vibrations generated by the rotation of the body.

19. The noise and vibration damping device of a rotation driving apparatus as claimed in claim 14, further comprising a damper member installed on an outer surface of the housing that dampens noises and vibrations generated by the rotation of the body.

20. The noise and vibration damping device of a rotation driving apparatus as claimed in claim 15, further comprising a damper member installed on an outer surface of the housing that dampens noises and vibrations generated by the rotation of the body.
